(19) United States
(12) Patent Application Publication
(10) Pub. No.: US 2001/0048639 A1
(43) Pub. Date: Dec. 6, 2001

(54) System for monitoring, processing, and presenting sleep time data

(76) Inventor: Daniel L. Davidson, New York, NY (US)

Correspondence Address: BEYER WEAVER & THOMAS LLP, P.O. BOX 778, BERKELEY, CA, 94704-0778, US

(21) Appl. No.: 09/741,648

(22) Filed: Dec. 18, 2000

Related U.S. Application Data
(60) Provisional application No. 60/174,421, filed on Jan. 4, 2000.
(60) Provisional application No. 60/186,044, filed on Mar. 1, 2000.

(51) Int. Cl. G04C 21/00; G04C 23/00; G04B 23/02

(52) U.S. Cl. 368/82; 368/107

(57) ABSTRACT

A timer device utilized both as conventional alarm clock and a snooze-timer that incorporates historical user data and enhanced display modes to facilitate the display of information and correlation of mood or performance with sleep time. The device includes a housing having a display unit, at least one button-type switch, a central processing unit, a clock, and a memory. According to one implementation, the central processing unit, clock and memory are contained in a single microprocessor chip.

### RELATED APPLICATION DATA

The present application claims priority from U.S. Provisional Application No. 60/174,421 for SYSTEM FOR PRESENTING SLEEP TIME REMAINING ON ALARM CLOCK DEVICE filed Jan. 4, 2000, and U.S. Provisional Application No. 60/186,044 for SYSTEM FOR RECORDING, ANALYZING, AND UTILIZING SLEEP TIME DATA filed Mar. 1, 2000, the entire disclosures of which are incorporated herein by reference for all purposes.

### BACKGROUND OF THE INVENTION

This invention relates generally to the field of timing and countdown devices, conventional alarm clocks, snooze alarms and more particularly, to such a device that provides functionality above that found in typical alarm clocks.

Most everybody agrees that both mood and performance are determined to a great extent by the amount of sleep received during the period prior to the period in which performance is measured. The invention described herein aims to provide both a method and device for enhancing the value that an alarm clock provides its user through the delivery of enhanced features and ease of use.

It is generally accepted that little or poor sleep will often result in poor performance, while oversleeping often results in a “groggy” or “foggy” mood, also compromising work performance or diminishing the enjoyment of daily life. We all search for just the “right” amount of sleep, and notably, this amount varies from individual to individual. The device described herein provides novel and substantial benefits not otherwise described in prior art or currently available.

Various types of timing and countdown devices have, of course, long been known in the prior art. For example, devices such as alarm clocks, cooking timers, etc. may be set such that they signal the user at a particular, preset time. In the case of an alarm clock, the device may be preset to sound its signal at a particular time of the day. In the case of a device such as a cooking timer, the device may be set to go off after a certain interval of time has elapsed.

Generally such devices provide only very basic functions, such as 1) actual or present time and 2) wake-up, alarm or snooze time. Further, such devices generally require more user input than would be necessary with a more efficient system to calculate, as an example, wake up time as a function of the then present time plus the addition of a fixed unit of time, in this case, the desired sleep time.

There is no known prior art timing or countdown device that provides substantial functionality beyond simply displaying time and signaling an alarm at a specified time. It is therefore desirable to provide devices having capabilities beyond these limited features.

### SUMMARY OF THE INVENTION

According to various embodiments of the present invention, systems are provided which notify the user of preset time to go to sleep, simplify the input of basic information and the setting of, for example, wake up time, calculate and display remaining sleep time, and utilize historical data as an input in calculating optimum sleep time for optimizing individual performance. According to one such embodiment, the user is notified, e.g., by an alarm chime, of the time when the sleep period should begin in order to ensure that an appropriate number of hours of sleep time could be achieved before a certain time. According to another embodiment, the user is able to set the alarm time for a specified length of time by activating one button without the need to calculate alarm time by adding the specified period of time to the then present time. According to another embodiment, the user is able to determine the amount of sleep time remaining prior to the signaling of an alarm without having to mentally calculate such a period by deducting the alarm time from the then present time. According to yet another embodiment, the user is able to determine her optimal sleep time duration by relying on an analysis of historical data which correlates length of sleep time with perceived mood and/or performance during the period following the sleep period. In general, the improvements presented by the embodiments of the present invention save the user time, help the user manage both time awake and time asleep, and assist in determining optimum periods of sleep time to maximize performance.

Thus, the present invention provides methods and apparatus for calculating and displaying remaining time on a clock. The remaining time is calculated using a current time and a previously specified future time. The remaining time is then displayed on the clock.

According to another embodiment, methods and apparatus are provided for specifying a future time on a clock. A specified time period input by a user is received. The future time is determined using a current time and the specified time period. The clock is then set to transmit a notification at the future time.

According to yet another embodiment, methods and apparatus are provided for monitoring sleep patterns. Sleep time data corresponding to a user for a plurality of sleep periods and mood data reported by the user are recorded. A suggested sleep time period is calculated and presented using the sleep time data and the mood data.

A further understanding of the nature and advantages of the present invention may be realized by reference to the remaining portions of the specification and the drawings.

### BRIEF DESCRIPTION OF THE DRAWINGS

FIG. 1 illustrates various display formats according to the present invention;

FIG. 2 depicts a daily log of wakeup time;

FIG. 3 depicts a daily log of time spent sleeping

FIG. 4 is a perspective view of the device with a standard display of time

FIG. 5 is a perspective view of the same device shown in FIG. 4, with a display of sleep time remaining.

FIG. 6 is a perspective view of a similar device with a dual display and mood/performance input buttons.

### DETAILED DESCRIPTION OF SPECIFIC EMBODIMENTS

Disclosed and claimed herein is a timing device with a variety of advantageous functions relative to a typical alarm clock and timing device. According to further embodiments, additional enhancements are provided by which historical user data are employed with novel methods of calculating and displaying time and time remaining that together and independently provide substantial functionality and user benefits over devices currently available.

Notification of Time to Go to Sleep

Individuals generally go to sleep, or try to go to sleep, at a given time each night. Very often, however, such individuals are occupied with other tasks, such as watching television or working, and therefore they miss their targeted time to go to sleep. Such delayed onset of sleep will often result in either the individual not getting their chosen number of hours of sleep (ex. 8 hours) or they will sleep until a later time than desired in order to maintain their chosen number of hours of sleep. In either occurrence, generally this is a less than optimal outcome and very often will result in compromised performance by the individual in the period following that period of sleep.

According to one embodiment, this invention provides a chime or alarm that signals at such time that the individual generally desires to go to sleep. As an example, the chime can be set for 11:00 PM and at that time the chime will signal notifying the individual that it is time to prepare for and go to sleep. This chime could be activated in the same way that an individual would activate a wake up alarm, however this chime or signal would have a distinctive tone. While most wake-up tones are designed with the intent of removing one from the state of sleep with a generally loud high pitched tone, or series of tones, the invention described herein relies on a soothing or subtle tone or series of such tones that are conducive to sleep or, alternatively put, not designed to wake somebody up.

Sleep Time Button

Individuals generally believe that they need a certain number of hours of sleep each night. As an example, many people believe that they need 7.5 hours of sleep each night. Generally each time that an individual goes to sleep they will set their alarm for a wake up time through a mental calculation that is achieved by adding the desired number of hours of sleep time to the then current present time.

According to a specific embodiment, the invention provides a system in which the device calculates wake-up time or alarm time in such a manner that the individual simply programs the timing device once thereby providing a system in which a button can be activated at any future date or time, and by activating such button, the device readily calculates and sets the wake up alarm time without the user having to go through the mental process of calculating such time. As an example, the individual could set the chosen period of sleep time by using traditional mechanisms, e.g., buttons to specify hour and minute, to program the device to provide for 7 hours and 30 minutes of sleep time. Therefore, once the button is programmed, the appropriate wake up time is simply obtained by activating this element of the device irrespective of current time. This invention is quite useful as most individuals believe that they need “x” hours of sleep where “x” is a constant.

Benefits to the user include the simplicity of calculating and setting a wake up time by simply activating a switch or button thereby insuring that they will program the clock for a given amount of sleep-time remaining irrespective of the current time. For example, if the sleep-time remaining is set for 7 hours and 45 minutes and the current time is 10:23 p.m., by depressing the button, wake-time or alarm-time would automatically be calculated and set for 6:08 a.m. Alternatively, if the sleep-time remaining is set for 7 hours and 45 minutes and the current time is 11:31 p.m., by depressing the button, wake-time or alarm-time would automatically be calculated and set for 7:16 a.m.

Enhanced Display

Typical alarm clocks present current time as well as alarm time, or scheduled wakeup time. Very often, individuals will wake up after setting their alarm and going to sleep but prior to the alarm sounding. Generally, in this situation, individuals desire to know how much additional sleep time is remaining before the alarm will sound. This becomes a more pronounced issue when one wakes up prior to the alarm time and tries to calculate remaining sleep time while still “foggy” from sleep. In this case, for example, upon waking up, current time might indicate 4:49 a.m., alarm time indicates 6:30 a.m. and it is left up to the individual sleeping to determine that 1 hour and 41 minutes of sleep time remain.

Thus, according to one embodiment, this invention provides for a system of presenting time such that the individual can readily determine, through a display on the device, the sleep time remaining without having to go through the mental process of calculating such time, which can often create enough mental activity that the individual is less likely to be able to readily fall asleep again. The invention described herein proposes to display such sleep time remaining through either alternating modes of a single display or through a secondary display.

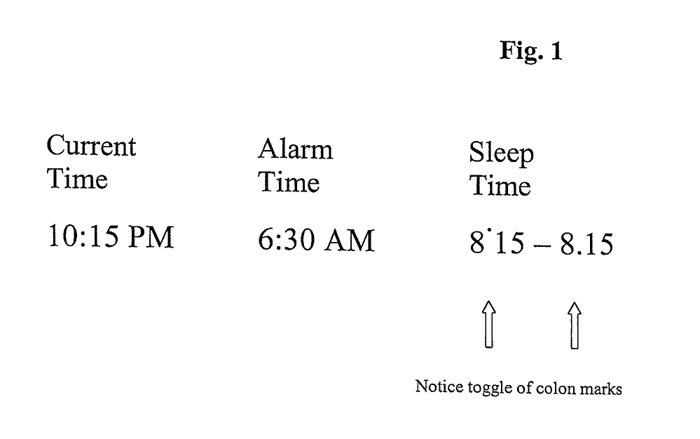

In the case of a single display, the individual can toggle between the 1) current time and wake up time and 2) sleep time remaining. In this situation either of the A) current time, or B) the sleep time remaining would be regularly displayed. In the case of a one-display system, one method of distinguishing between the current time and the sleep time is shown in FIG. 1 in which the colon separating the hour from the minute digits alternate between the two dots that comprise the colon. In such scenario the two dots that comprising the punctuation mark of the colon would light up, or be activated, on an alternating basis thereby indicating to the individual that the display was in sleep-time remaining mode.

The individual could simply toggle between the two display formats by the touch of a button. The button could shift from current time to sleep time and back to current time with the single touch and release of the button or could toggle from one format to the other each time the button is activated.

Utilizing Sleep Time Data

When the wake up alarm goes off, often people will “hit” the “snooze” button in order to sleep another X minutes. We have all done this believing that with just a few more minutes of sleep we will wake up that much more refreshed and ready to take on the daily tasks. As we all strive to understand what variables that we can change to make us more efficient and to enhance the quality of our lives we often look to change our diet, consumption of alcohol, cigarettes, sugar, caffeine, and even our sleep patterns. Recognizing that REM, NREM and other stages of sleep are complex, the invention described herein allows users to begin to apply a more quantitative approach to the period devoted to rest, and patterns of sleep, in an effort to improve the quality of our lives and the performance of our work or related activities.

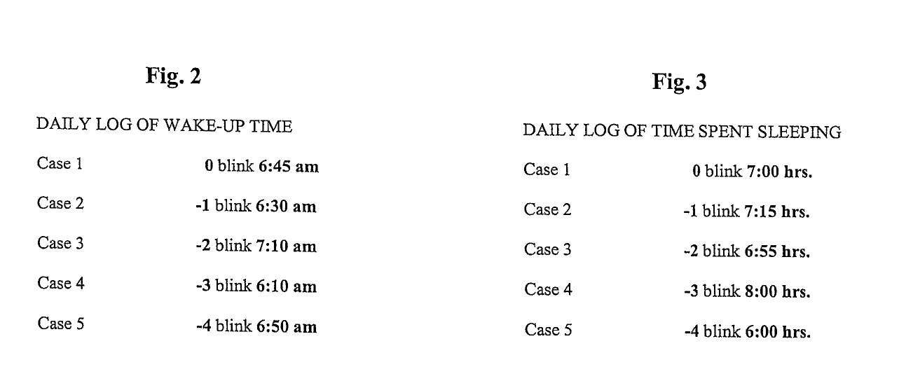

Utilizing this enhancement to available systems, an individual, prior to going to sleep, will activate a designated button to record the then current time. According to various embodiments, the time at which an individual “goes to sleep” may refer to the time at which the individual, might for example, close their eyes expecting to fall asleep within a reasonable period of time thereafter. Upon waking the individual will activate a designated button to record the then current time. Processing circuitry will calculate the amount of time between going to sleep and waking up. Each morning, as the time periods are recorded, they are stored in memory and are capable of being displayed, for example, in the manner outlined in FIGS. 2 and 3.

In Case 1 of FIG. 2, 0 indicates the present day and the actual wake up time of 6:45 am.

In Case 2, −1 indicates the prior day and the actual wake up time of 6:30 am.

In Case 3, −2 indicates 2 days prior to the present day and an actual wake up time of 7:10 am, etc.

In Case 1 of FIG. 3, 0 indicates the present day and the actual sleep time of 7:00 hours.

In Case 2, −1 indicates the prior day and the actual sleep time of 7 hours 15 minutes.

In Case 3, −2 indicates 2 days prior to the present day and an actual sleep time of 6 hours and 55 minutes, etc.

While the method and style of display might vary, the present invention covers the utility of recording, processing, correlating and storing, various elements of information in the individual's sleep related activity for purposes that could be beneficial to the individual. Alternatively, the device could provide a printed report of historical sleep time data. Or relay such information to a computer for storage, display and print out on another device. Such milestones recorded may include, but are not limited to:

Actual time of “going to sleep” (see definition above)

Set time to wake up

Delay in wake up resulting from activation of “snooze” function

Actual time of waking up

Time period between going to sleep and waking up

Mood, emotion or feeling at the time of waking up.

A further embodiment incorporates the application of results from the recording and calculation of certain data relating to the user's periods of sleep, for practical purposes, such as a rhythm calculator that analyses a sequence of wake up times and evaluates trends. As an example, the clock calculates an average time slept over a period of days (e.g., 30 days) and, based on such computations, “suggests” to the user that 7 hours and 10 minutes appears to be the “ideal” amount of sleep time based on additional data provided by the user such as the mood, emotion or feeling following the sleep period.

In this case, a quantitative value representing mood, feeling or emotion, on a scale of 1-10, for example, is entered into the clock apparatus by the user at the time of wake up. This value is used in calculating the optimum sleep time. It will be understood that the present invention includes a variety of other techniques and mechanisms by which mood or performance data may be input and measured, i.e., any number of buttons or switches could be used to enter a wide variety of information on any type of arbitrary scale. The scope of the invention should therefore not be limited to the scale and mechanism described.

Linking to Other Devices:

An additional embodiment utilizes technology to send all such data to a computer through either a wired or wireless system. While many technologies exist today for connecting two discrete systems, one example, Bluetooth Technology answers the need for short-range wireless connectivity. The Bluetooth system specifies a solution comprising hardware, software and interoperability requirements. The Bluetooth radio operates in a globally available 2.4 Ghz ISM band, ensuring communication compatibility worldwide.

According to one such embodiment, the alarm clock equipped with the enhancements of the present invention could record wake up times in a period, for example, comprising 30 days, turn the lights and coffee pot on at the time of wake-up, and provide critical data regarding sleep times to a computer for analysis. The software resident on the computer system could, in turn, set the alarm clock for a specified wake-up time based on a meeting schedule or by analysis of wake up time data as instructed by the user.

Flexible Snooze Time

Most clock that have “snooze” buttons allow the user to temporarily delay the alarm activity by a set number of minutes, typically between 7 and 15 minutes. If the user wants to sleep for an additional 25 minutes beyond the alarm time they would need to, for example, activate the snooze button every 7 minutes, or a total of 4 times. This activity generally interrupts sleep such that the additional sleep time received is not contiguous and therefore of little additional value. A clock incorporating an enhancement as defined herein would allow the user to set the incremental delay in alarm time from the generally preset limit of 7 minutes (for example) to a number of minutes of the user's choice (for example 20 minutes). Each time that the user activates the snooze button, the total number of hours/minutes of sleep is adjusted accordingly by adding any additional sleep time received by the user to the original sleep time received by the user, to reflect a new total sleep time and the value of which will be used in calculating “optimum” sleep time.

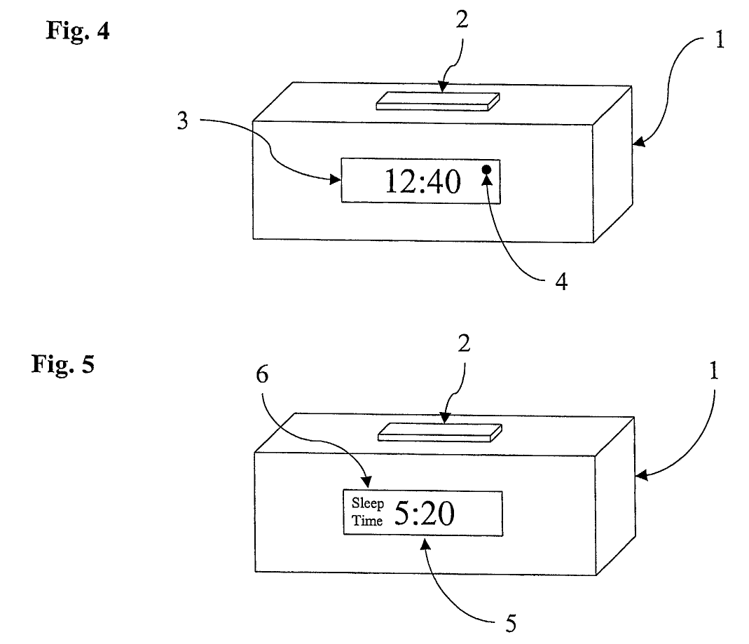

Reference is directed to FIGS. 4 and 5, which illustrate a specific embodiment of the device 1 including a housing having a single depressable button-type switch 2 and a single display unit 3, in this instance demonstrating the time. The display unit 3 may be, for example, a liquid crystal display (LCD), and may incorporate a PM indicator 4. The display can also take the form of an “LED” (light emitting diode) or other display technology. Sleep time remaining 5 is further indicated by an element of the display 6. Depressable button-type switch 2 may be used (as described above) to set the wake-up time based on the previously specified desired sleep period. According to another embodiment, switch 2 could alternately be used to toggle back and forth between actual time and sleep time remaining on a single display.

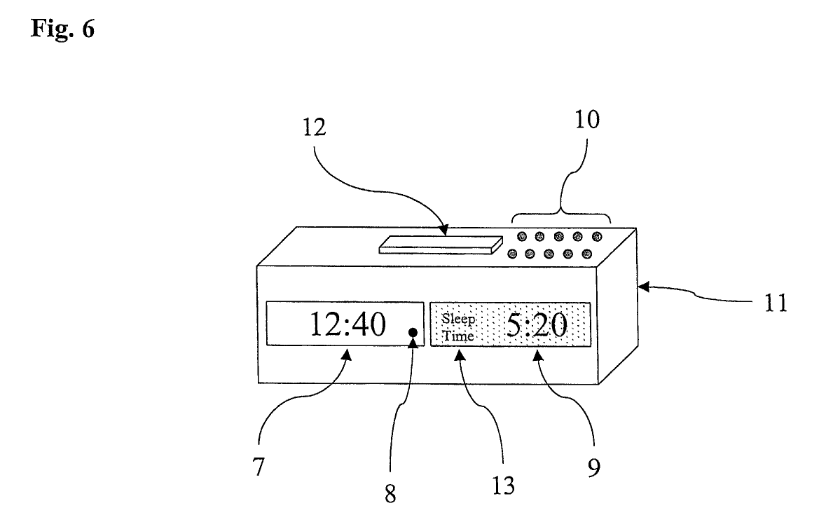

FIG. 6 illustrates another embodiment of the present invention. Snooze-timer device 11 includes a housing having a single depressable button-type switch 12 (e.g., having similar functionality as switch 2 above) and a dual display 7 and 9. In this instance time is displayed 7, and sleep time remaining is indicated 9. The display units are preferably a liquid crystal display (LCD). The display can also take the form of an “LED” (light emitting diode) or other display technology. Sleep time remaining 9 is further indicated by an element of the display 13. PM is indicated 8. Depressable buttons 10 are activated to indicate mood 10 (for the purpose described above) following the period of wake up.

While the invention has been particularly shown and described with reference to specific embodiments thereof, it will be understood by those skilled in the art that changes in the form and details of the disclosed embodiments may be made without departing from the spirit or scope of the invention. For example, the present invention has been described with reference to stand-alone timing devices. It will be understood, however, that the principles of the present invention as described herein may be implemented in a variety of ways including, for example, via the interfaces and software objects of a personal computer or internet appliance. Therefore, the scope of the invention should be determined with reference to the appended claims.

What is claimed is:

1. A method for calculating and displaying remaining time on a clock, comprising:
calculating the remaining time using a current time and a previously specified future time; and
displaying the remaining time on the clock.

2. A clock, comprising:
at least one display for displaying a current time and a remaining time; and
circuitry for calculating the remaining time using the current time and a previously specified future time.

3. The clock of claim 2 wherein the circuitry is further configured to calculate the previously specified future time in response to receiving a specified period of time input by a user.

4. The clock of claim 3 further comprising a switch, the circuitry being configured to calculate the previously specified future time in response to a single actuation of the switch.

5. The clock of claim 3 further comprising notification circuitry for transmitting a notification at the previously specified future time.

6. The clock of claim 2 wherein the circuitry is further configured to record sleep time data corresponding to a user for a plurality of sleep periods.

7. The clock of claim 6 wherein the circuitry is further configured to record mood data reported by the user.

8. The clock of claim 7 wherein the circuitry is further configured to calculate and present a suggested sleep time period using the sleep time data and the mood data.

9. A computer program product for calculating and displaying remaining time, comprising:
at least one display object for displaying a current time and a remaining time; and
at least one software object for calculating the remaining time using the current time and a previously specified future time.

10. A method for specifying a future time on a clock, comprising:
receiving a specified time period input by a user;
determining the future time using a current time and the specified time period; and
setting the clock to transmit a notification at the future time.

11. A clock, comprising:
a user interface for specifying a period of time;
calculation circuitry for calculating a future time using a current time and the specified period of time; and
notification circuitry for transmitting a notification at the future time.

12. The clock of claim 11 further comprising snooze circuitry for adding a snooze period to the specified period of time, the notification circuitry being configured to transmit a second notification after the snooze period has expired.

13. The clock of claim 12 wherein snooze period is programmable.

14. A computer program product for specifying a future time, comprising:
an input object for specifying a period of time;
a software object for calculating a future time using a current time and the specified period of time; and
a notification object for transmitting a notification at the future time.

15. An apparatus for monitoring sleep patterns comprising circuitry configured to record sleep time data corresponding to a user for a plurality of sleep periods and mood data reported by the user, and calculate and present a suggested sleep time period using the sleep time data and the mood data.

16. A computer program product for monitoring sleep patterns comprising computer program instructions for recording sleep time data corresponding to a user for a plurality of sleep periods and mood data reported by the user, and computer program instructions for calculating and presenting a suggested sleep time period using the sleep time data and the mood data.
